(19) United States
(12) Patent Application Publication
(10) Pub. No.: US 2004/0007991 A1
(43) Pub. Date: Jan. 15, 2004

(54) Apparatus for controlling fluorescent lamp and scanning apparatus having the same

(75) Inventors: Han-Chung Ryu, Sungnam-City (KR); Jong-Yang Choo, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/443,064

(22) Filed: May 22, 2003

(30) Foreign Application Priority Data
Jul. 10, 2002 (KR) 2002-40104

(51) Int. Cl. H05B 37/02

(52) U.S. Cl. 315/291; 315/276

(57) ABSTRACT

An apparatus controlling a cold cathode fluorescent lamp and a scanning apparatus having the same are disclosed. The scanning apparatus including the fluorescent lamp and a scan unit comprises: a central processing unit (CPU) controlling the scan unit to be in one of the stand-by mode, the scan mode and the sleep mode and outputting a square signal having a variable duty ratio based on the operation mode of the scan unit; a rectifying unit receiving the square wave signal from the CPU, rectifying the square wave signal into the level of DC voltage based on the duty ratio of the square wave signal, and outputting the rectified DC voltage; a feedback unit detecting the voltage applied to the fluorescent lamp and outputting the detected voltage as a feedback signal; a controlling unit controlling the illumination of the fluorescent lamp based on the voltage that is inputted from the feedback unit, the controlling unit outputting a control signal variably controlling the voltage applied to the fluorescent lamp depending on the level of DC voltage that is inputted from the rectifying unit; and a drive unit applying variable AC voltage to the fluorescent lamp based on the control signal that is inputted from the controlling unit, thereby driving the fluorescent lamp. Accordingly, it is possible to control the luminous-intensity of the fluorescent lamp, reduce the preheating time of the fluorescent lamp, greatly extend the fluorescent lamp's lifetime, and lower the power consumption.

### CROSS-REFERENCE TO RELATED APPLICATIONS

This application claims the benefit of Korean Application No. 2002-40104, filed Jul. 10, 2002, in the Korean Intellectual Property Office, the disclosure of which is incorporated herein by reference.

### BACKGROUND OF THE INVENTION

1. Field of the Invention

The present invention relates generally to an apparatus controlling a fluorescent lamp and a scanning apparatus having the same, and more particularly to an apparatus capable of variably controlling the fluorescent lamp and a scanning apparatus having the same.

2. Description of the Related Art

The cold cathode fluorescent lamp is widely utilized as a backlight source to illuminate the display panel of a liquid crystal display that is used as a display, such as in a portable notebook computer and the like, or as a light source constantly illuminating a manuscript in a scanning apparatus.

In order to drive a cold cathode fluorescent lamp, it is common to generate a pulse wave through a switching device such as a transistor and to boost the generated pulse wave to a high voltage of more than 500 Vrms having a frequency equal to or above 200 KHz in a winding-type transformer applied to the cold cathode fluorescent lamp. The operation of the conventional fluorescent lamp controlling apparatus will be described with reference to FIG. 1.

As shown in FIG. 1, according to the fluorescent lamp controlling apparatus, when the power supply switch S1 is turned on, a first transistor Q1 is activated by the voltage divided by a first resistor R1, a second resistor R2 and a third resistor R3, which form the voltage-dividing resistor. A first diode D1 and a first capacitor C1 are a circuit protecting the first transistor Q1 from counter electromotive force that is induced by a first inductor L1. The current output from the collector terminal of the first transistor Q1 is dropped to a predetermined voltage in a fourth resistor R4 and a fifth resistor R5 through the first inductor L1, and then the dropped voltage is applied to the respective base terminals of a second transistor Q2 and a third transistor Q3, and to the respective collector terminals of the second transistor Q2 and the third transistor Q3 through a second inductor L2 and a fourth inductor L4. A fifth inductor L5 is provided between the base terminals of the second transistor Q2 and the third transistor Q3, and hence only the single transistor begins to activate, resulting in the second transistor Q2 and the third transistor Q3 having an active state and a cut-off state that are alternatively iterated. The electromotive forces in opposite directions are alternatively generated in the second inductor L2 and the third inductor L3, respectively, and hence a secondary electromotive force of the high voltage having high frequency is generated in a third inductor L3 placed on the secondary side of transformer T1 which forms parallel-resonance with the second capacitor C2.

As described in the above, according to the conventional fluorescent lamp controlling apparatus, when the power supply switch S1 is turned on, a constant drive voltage is applied to the fluorescent lamp, whereas when the power supply switch S1 is turned off, the drive circuit is not operated and no drive voltage is applied to the fluorescent lamp. Consequently, the conventional fluorescent lamp controlling apparatus can not variably control the voltage applied to the fluorescent lamp, takes a long time to initially operate the fluorescent lamp because of the longer initial preheating time thereof, reduces the fluorescent lamp's lifetime, and causes higher power consumption.

### SUMMARY OF THE INVENTION

Accordingly, the present invention has been made to solve the above-mentioned and/or other problems, and an aspect of the present invention is to provide an apparatus controlling a fluorescent lamp and a scanning apparatus having the same which can freely control the luminous-intensity of the fluorescent lamp, reduce the initial preheating time of the fluorescent lamp, constantly control the luminous-intensity of the fluorescent lamp in the operation mode, greatly extend the fluorescent lamp's lifetime by interrupting the voltage applied thereto in a stand-by mode, and lower the power consumption.

In accordance with one aspect of the present invention, an apparatus controlling a fluorescent lamp comprises a feedback unit detecting the voltage applied to the fluorescent lamp and outputting the detected voltage as a feedback signal, a controlling unit receiving the feedback signal output from the feedback unit and controlling the luminous-intensity of the fluorescent lamp, the controlling unit outputting a control signal variably controlling the voltage applied to the fluorescent lamp based on an externally inputted luminous intensity adjusting signal, and a drive unit applying variable AC voltage to the fluorescent lamp based on the control signal inputted from the controlling unit and driving the fluorescent lamp.

The feedback unit comprises a diode and a capacitor receiving AC voltage applied to the fluorescent lamp, rectifying the AC voltage to DC voltage, and outputting the rectified DC voltage, and a resistor element provided so as to output the rectified DC voltage as the feedback signal to the capacitor.

The controlling unit comprises a reference voltage source generating a predetermined DC voltage, an error amplifier amplifying the voltage difference of a second input voltage and a first input voltage and outputting the amplified voltage difference, and a first resistor connected in series with the output terminal of the error amplifier limiting the amount of current output from the error amplifier.

The first input voltage is the summation of the feedback signal output from the feedback unit and the reference voltage output from the reference voltage source. And, a second input voltage receives the externally inputted luminous-intensity adjusting signal.

The drive unit comprises a power supply source supplying DC power, a transistor having a base terminal receiving the DC signal output from the controlling unit outputting and interrupting a variable collector current thereof in a given period based on the base current that is inputted to the base terminal, thereby iteratively switching the collector current, a first inductor connected between the power supply source and the collector terminal of the transistor generating a variable primary electromotive force, depending on the current that is outputted and interrupted from the collector terminal in a given period, a second inductor coupling-connected to the first inductor generating a secondary inductive electromotive force that is induced from the primary electromotive force and boosted by a given multiple, and a capacitor connected in parallel with the second inductor providing the fluorescent lamp with the high voltage of high frequency which is generated by forming resonance with the second inductor in a given period.

The drive unit may further comprise a third inductor generating an inductive electromotive force having the same direction as that of the electromotive force that is generated by the first inductor and boosting a forward bias voltage and a backward bias voltage that are applied to the base terminal of the transistor, the third inductor connected between the output terminal of the controlling unit and the base terminal of the transistor and coupling-connected to the first inductor.

In accordance with another aspect of the present invention, a scanning apparatus includes the fluorescent lamp illuminating the manuscript and a scan unit receiving the light reflected from the manuscript and scanning the manuscript. A central processing unit (CPU) controls the operation mode of the scan unit to be one of a stand-by mode, a scan mode or a sleep mode, and outputs a square wave signal having variable duty ratio based on the operation mode of the scan unit. A rectifying unit receives the square wave signal from the CPU, rectifying the square wave signal into different levels of DC voltage based on the duty ratio of the square wave signal, and outputs the rectified DC voltage. A feedback unit detects the voltage applied to the fluorescent lamp and outputs the detected voltage as a feedback signal. A controlling unit controls the voltage applied to the fluorescent lamp based on the feedback signal that is inputted from the feedback unit, the controlling unit outputting a control signal variably controlling the voltage applied to the fluorescent lamp according to the level of the DC voltage that is inputted from the rectifying unit. A drive unit applies variable AC voltage to the fluorescent lamp based on the control signal that is inputted from the controlling unit, thereby driving the fluorescent lamp.

The rectifying unit comprises a resistor element dropping the voltage of the square wave signal that is inputted from the CPU and outputting the dropped voltage, and a capacitor connected in parallel between the output terminal of the resistor and a ground terminal rectifying the dropped voltage of the square wave signal into the DC voltage.

The controlling unit comprises a reference voltage source generating a predetermined DC voltage, an error amplifier amplifying the voltage difference of a second input voltage and a first input voltage and outputting the amplified voltage difference, and a first resistor connected in series with the output terminal of the error amplifier limiting the amount of current output from the error amplifier.

The first input voltage is the summation of the feedback signal output from the feedback unit and the reference voltage output from the reference voltage source. And, a second input voltage receives an externally inputted luminous-intensity adjusting signal.

The drive unit comprises a power supply source supplying DC power supply, a transistor having a base terminal receiving the DC signal output from the controlling unit outputting and interrupting variable collector current thereof based on a period of the base current that is inputted to the base terminal, thereby iteratively switching the collector current. A first inductor connected between the power supply source and the collector terminal of the transistor generates a variable primary electromotive force based on the current that is outputted and interrupted from the collector terminal in a given period, a second inductor coupling-connected to the first inductor for generating a secondary inductive electromotive force that is induced from the primary electromotive force and boosted by a given multiple, and a capacitor connected in parallel with the second inductor provides the fluorescent lamp with the high voltage of high frequency which is generated by forming resonance with the second inductor in a given period.

The drive unit may further comprise a third inductor generating an inductive electromotive force having the same direction as that of the electromotive force that is generated by the first inductor and boosting forward bias voltage and backward bias voltage that are applied to the base terminal of the transistor, the third inductor being connected between the output terminal of the controlling unit and the base terminal of the transistor and being coupling-connected to the first inductor.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects, features and advantages of the present invention will be more apparent from the following detailed description taken in conjunction with the accompanying drawings, in which:

FIG. 1 is a circuit diagram illustrating a conventional fluorescent lamp drive circuit;

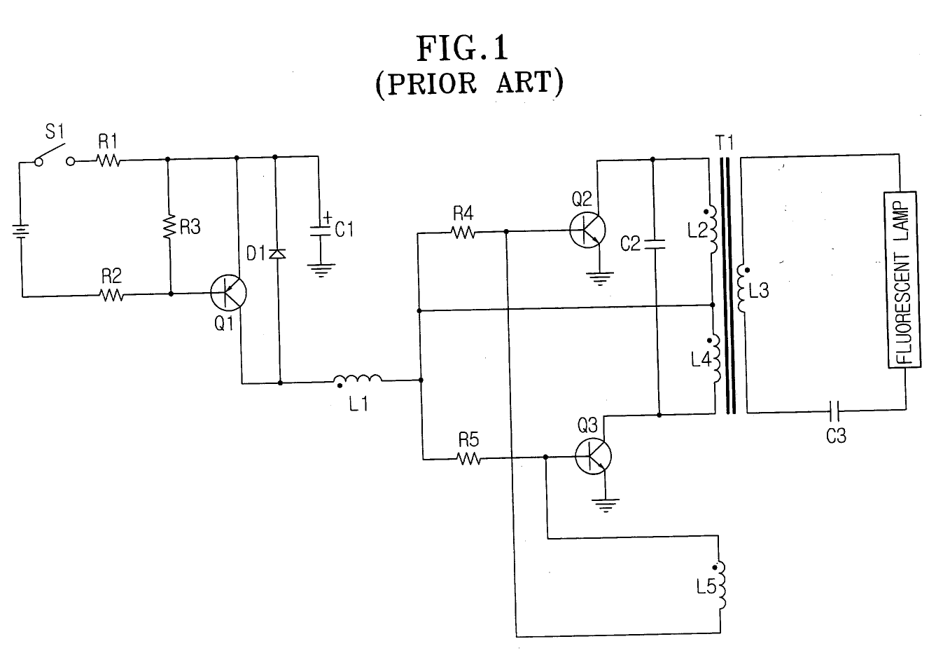

FIG. 2 is a circuit diagram illustrating an apparatus controlling a fluorescent lamp according to an embodiment of the present invention;

FIG. 3 shows a scanning apparatus to which the apparatus controlling the fluorescent lamp shown in FIG. 2 is applied; and

FIG. 4 is a sketch representing the duty ratio as a function of time of the pulse signal that is applied to the fluorescent lamp controlling apparatus in response to the respective operation modes of the scan unit shown in FIG. 3.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

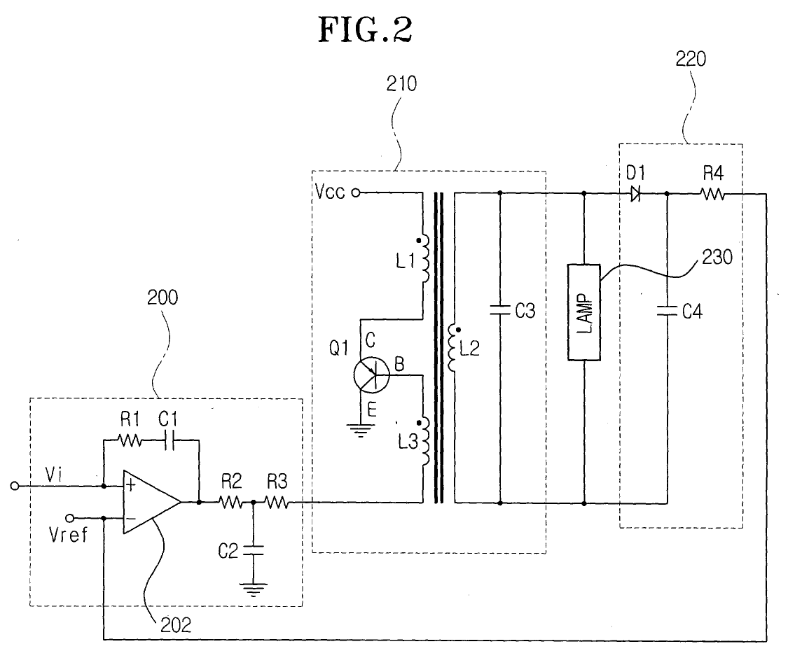

Hereinafter, the description will be made as to an embodiment of the present invention with reference to FIG. 2. In the following description of the present invention, a detailed description of known functions and configurations incorporated herein will be omitted when it may make the subject matter of the present invention rather unclear.

FIG. 2 is a circuit diagram illustrating an apparatus controlling a fluorescent lamp according to an embodiment of the present invention. As shown in FIG. 2, the apparatus controlling the fluorescent lamp comprises a controlling unit 200, a drive unit 210, and a feedback unit 220.

The feedback unit 220 detects the voltage applied to the fluorescent lamp 230, and outputs the detected voltage as a feedback signal to the controlling unit 200. Since a first diode D1 and a fourth capacitor C4 of the feedback unit 220 are connected in series between the output terminal of the drive unit 210 and a ground terminal, the rectified voltage is outputted from the junction of the first diode D1 and the fourth capacitor C4 and a fourth resistor R4 outputs the outputted high voltage as a dropped voltage feedback signal to the controlling unit 200.

The controlling unit 200 uses a reference voltage source generating a predetermined DC voltage (V_{ref}). Also, the controlling unit 200 comprises an error amplifier 202 that has an inverting terminal receiving a first input voltage and a non-inverting terminal receiving a luminous-intensity adjusting signal externally inputted as a second input voltage, amplifies the voltage difference of the second input voltage for the first input voltage, and outputs the amplified voltage difference. The first input voltage is the summation of the voltage output from the feedback unit and the reference voltage output from the reference voltage source. A first resistor R1 and a first capacitor C1 of the controlling unit 200 are connected in series between the output terminal of the error amplifier 202 and the non-inverting terminal thereof, thereby canceling out the oscillation components of the voltage output from the error amplifier 202. Also, a second resistor R2 and a second capacitor C2 of the controlling unit 200 are connected in series between the output terminal of the error amplifier 202 and the ground terminal, thereby rectifying the ripple voltage of the voltage that is outputted from the error amplifier 202. A third resistor R3 limits the amount of current that is rectified and outputted, and outputs the limited current to the drive unit 210.

The drive unit 210 variably drives the luminous-intensity of the fluorescent lamp 230 based on a signal that is inputted from the controlling unit 200. A first inductor L1 of the driving unit 210 is provided between a power supply source supplying a given DC voltage and the collector terminal C of a first transistor Q1. The first transistor Q1 of the drive unit 210 is activated by receiving DC current input from the controlling unit 200 at its base terminal B, thereby flowing current through the first inductor L1 that is connected as a load to the collector terminal C. If the amount of current flowing through the first inductor L1 gradually increases and generates primary electromotive force, and thereafter the amount of current flowing through the first inductor L1 exceeds the saturation current amount (the current amplification factor h_{FE} for the base current I_{B} of the first transistor Q1), the first transistor Q1 enters into a cut-off state, cutting off the current flowing through the first inductor L1. Thus, the first transistor Q1 repeats in a given period the switching operation that generates forward and backward electromotive forces in the first inductor L1. And, a third inductor L3 is provided between the base input terminal of the first transistor Q1 and a third resistor R3 of the controlling unit 200 and provides the electromotive force having the same direction as that of the first inductor, thereby boosting the forward and backward bias voltages that are applied to the first transistor Q1. A second inductor L2 of the controlling unit 200 generates secondary electromotive force that is induced by the primary electromotive force generated from the first inductor L1 and is boosted by a given multiple. A third capacitor C3 is connected in parallel between the output terminal of the second inductor L2 and the ground terminal and forms resonance with a certain resonant frequency, thereby applying the high voltage having higher frequency generated in the second inductor L2 to the fluorescent lamp 230.

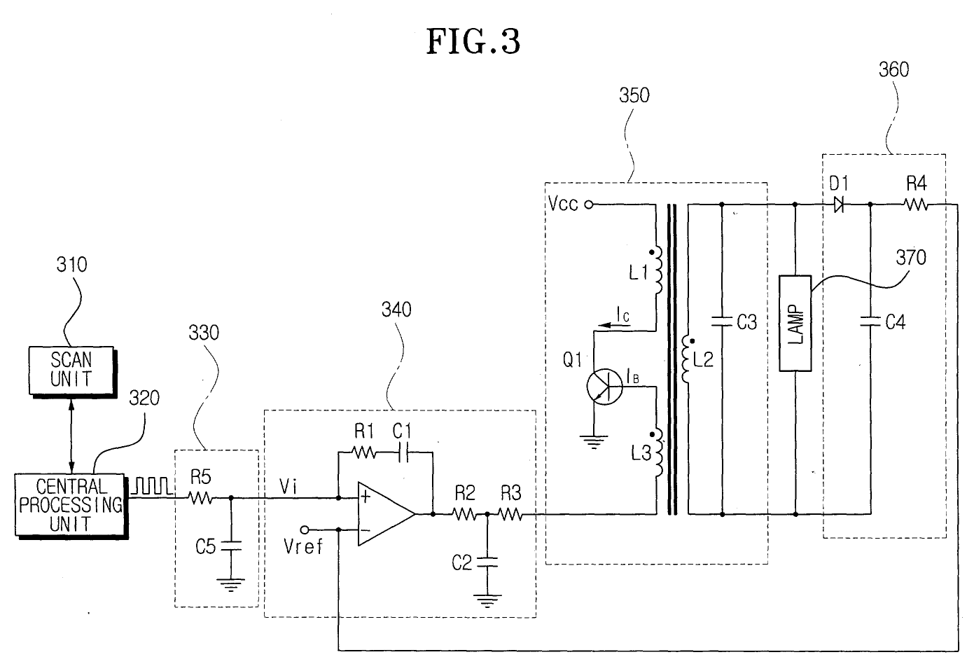

The operation of an embodiment of the scanning apparatus comprising the fluorescent lamp controlling apparatus according to the present invention will be explained in detail with reference to FIG. 3.

FIG. 3 shows an embodiment of the scanning apparatus to that the fluorescent lamp controlling apparatus shown in FIG. 2 is applied. As shown in FIG. 3, the scanning apparatus comprises a scan unit 310, a central processing unit (CPU) 320, a rectifying unit 330, a controlling unit 340, a drive unit 350, and a feedback unit 360.

The scan unit 310 operates in one of the stand-by mode, the scan mode or the sleep mode based on a control signal from the CPU 320. The CPU 320 outputs a square wave signal having a variable duty ratio according to the operation mode of the scan unit. The rectifying unit 330 receives the square wave signal from the CPU 320, rectifies the square wave signal into different levels of DC voltage based on the duty ratio of the square wave signal, and outputs the rectified DC voltage to the controlling unit 340. The feedback unit 360 detects the voltage applied to the fluorescent lamp 370 and feedbacks the detected voltage to the controlling unit 340. The controlling unit 340 constantly controls the luminous-intensity of the fluorescent lamp 370 based on the voltage that is inputted from the feedback unit 360, and outputs to the drive unit 350 a control signal variably controlling the luminous-intensity of the fluorescent lamp 370 based on the level of voltage that is inputted from the rectifying unit 330. The drive unit 350 supplies variable voltage to the fluorescent lamp 370 based on the control signal that is inputted from the controlling unit 340, thereby driving the fluorescent lamp 370.

When the scan unit 310 is provided with power, the CPU 320 controls the scan unit 310 to be in the stand-by mode without outputting the square wave signal so that the scan unit 310 can be quickly switched to the scan mode when the CPU 320 issues the scan command.

If the CPU 320 issues a scan command as a result of an external input while the scan unit 310 is in of the sleep mode or the stand-by mode, the CPU outputs the square wave signal having a certain duty ratio (for example, 90%) for a certain short time. This results in rapidly preheating the fluorescent lamp 370. The duty ratio needs to be high enough to cause the drive unit 350 to provide the fluorescent lamp 370 with the maximum voltage applicable thereto, but without an instantaneous change from zero to maximum voltage so as to prevent the excess current from flowing through the fluorescent lamp 370 in an initial state, i.e., when the fluorescent lamp 370 is at a low temperature and low impedance. Thereafter, the CPU 320 controls the scan unit 310 to be in the scan mode, and outputs the square wave signal having a certain duty ratio (for example, 50%) while the scan unit 310 performs the scanning operation. The certain duty ratio needs to be high enough to cause the fluorescent lamp 370 to stably emit the light in a constant amount.

If the scanning operation of the scan unit 310 is completed, the CPU 320 controls the scan unit 310 to be in the stand-by mode and hence interrupts output of the square wave signal that has been outputted to the rectifying unit 330.

Also, if the CPU 320 is not provided with an externally inputted scan command for a given period while controlling the scan unit 310 to be in the stand-by mode, the CPU directs the scan unit 310 to go to the sleep mode, thereby minimizing the power consumption of the scan unit.

A fifth resistor R5 and a fifth capacitor C5 of the rectifying unit 330 are connected in series between an input terminal which receives the square wave signal output from the CPU 320 and a ground terminal. The square wave signal is rectified into a DC level voltage that is dropped based on the duty ratio of the square wave signal and is outputted as rectified DC voltage.

The operations of the controlling unit 340, the drive unit 350, and the feedback unit 360 are identical to those described in the apparatus controlling the fluorescent lamp as described above.

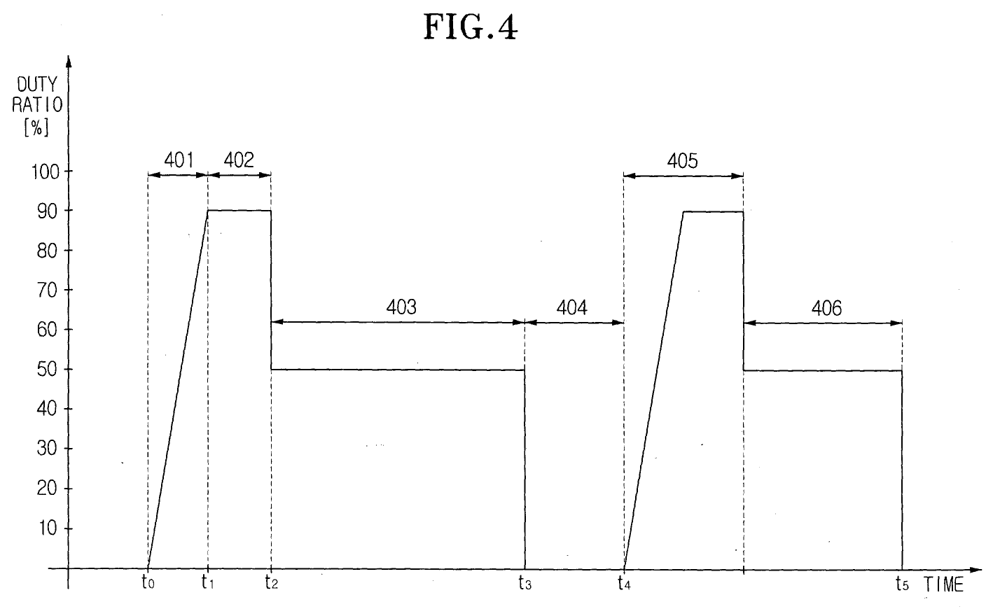

The variations of the duty ratio of the square wave signal that is outputted from the CPU 320 in response to the respective operation modes of the scan unit 310 will be explained in detail by referring to FIG. 4. FIG. 4 is a sketch representing the duty ratio as a function of time of the pulse signal that is applied to the apparatus controlling the fluorescent lamp in response to the respective operation modes of the scan unit shown in FIG. 3.

In an initial state, as the scan unit 310 is provided with power, and as the CPU 320 receives the scan command at time t₀ while controlling the scan unit 310 to be in stand-by mode, the CPU 320 gradually increases the duty ratio of the output square wave signal from 0% to 90% during time interval 401 (t₀˜t₁), maintains the duty ratio at 90% during a given time interval 402 (t₁˜t₂), and outputs the square wave signal to the rectifying unit 330, thereby causing the drive unit 350 to provide the fluorescent lamp 370 with the maximum voltage applicable thereto to rapidly preheat the fluorescent lamp 370. Thereafter, the CPU 320 controls the scan unit 310 to be in the scan mode and maintains the duty ratio of the square wave signal at 50% during time interval 403 (t₂˜t₃) in which the scan unit 301 performs the scanning operation. As the scanning operation of the scan unit 310 is completed, the CPU 320 controls the scan unit 310 to be in the stand-by mode 404 (t₃˜t₄), interrupting the output of the square wave signal and thus, interrupting the voltage applied to the fluorescent lamp 370. When the CPU 320 does not receive an externally inputted scan command for a given period while the scan unit 310 is in the stand-by mode, the CPU 320 directs the scan unit 310 to be in the sleep mode. During time intervals 405 and 406 beginning with the time t₄, the CPU 320 receives an externally inputted scan command and the CPU 320 repeats the operations performed in the time intervals 401, 402 and 403 in which the CPU 320 gradually increases the duty ratio of the square wave signal to 90% and then maintains the duty ratio of the square wave signal at 50%.

As described in the foregoing, it is possible to variably control the luminous-intensity of the fluorescent lamp 370 by controlling the voltage applied to the fluorescent lamp 370 depending on the voltage level of the luminous intensity adjusting signal that is inputted to the controlling unit 340. The voltage that is applied to the fluorescent lamp 370 is more easily controlled by variably adjusting the duty ratio output to the CPU 320, and to preheat the fluorescent lamp 370 which is under low temperature and low impedance in the shortest time by non-linearly increasing the duty ratio according to the characteristic of the fluorescent lamp 370 as well as linearly increasing the duty ratio of the square wave signal that is outputted from the CPU 320.

In accordance with the apparatus controlling the fluorescent lamp according to the present invention, it is possible to variably control the luminous-intensity of the fluorescent lamp. In accordance with the scanning apparatus comprising the apparatus controlling the fluorescent lamp according to the present invention, it is possible to preheat the fluorescent lamp under low temperature and low impedance in the shortest time and to greatly extend the fluorescent lamp's lifetime by interrupting the voltage applied to the fluorescent lamp even when the scan unit operates in the stand-by mode, thereby reducing the power consumption.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus controlling a fluorescent lamp comprising:
a feedback unit detecting a voltage applied to the fluorescent lamp and outputting the detected voltage as a feedback signal;
a controlling unit receiving the feedback signal output from said feedback unit and controlling luminous-intensity of the fluorescent lamp, said controlling unit outputting a control signal variably controlling the voltage applied to the fluorescent lamp according to an externally inputted luminous intensity adjusting signal; and
a driving unit applying variable AC voltage to the fluorescent lamp based on the control signal from said controlling unit and driving the fluorescent lamp.

2. The apparatus according to claim 1, wherein said feedback unit comprises:
a diode and a capacitor receiving AC voltage applied to the fluorescent lamp, rectifying the AC voltage to DC voltage, and outputting the rectified DC voltage; and
a resistor element connected so as to output the rectified DC voltage as the feedback signal to said controlling unit.

3. The apparatus according to claim 1, wherein said controlling unit receives a reference voltage from a reference voltage source generating a given DC voltage; and
wherein said controlling unit receives a first input voltage and the luminous-intensity adjusting signal inputted externally as a second input voltage and outputs a signal to said drive unit that is proportional to the magnitude of a voltage difference between the second input voltage and the first input voltage, the first input voltage being the summation of the feedback signal output from said feedback unit and the reference voltage output from said reference voltage source.

4. The apparatus according to claim 3, wherein said controlling unit further comprises:
an error amplifier amplifying the voltage difference and outputting the amplified voltage difference, said error amplifier having an inverting terminal that is inputted with the first input voltage and a non-inverting terminal that is inputted with the second input voltage; and
a first resistor connected in series with an output terminal of said error amplifier limiting the amount of current that is outputted from said error amplifier.

5. The apparatus according to claim 4, wherein said controlling unit further comprises:
a first capacitor and a first resistor connected in series between the output terminal of said error amplifier and said non-inverting terminal to cancel out the oscillation of the output voltage of said error amplifier; and
a second resistor and a second capacitor connected in series between the output terminal of said error amplifier and a potential rectifying a ripple voltage in the output voltage of said error amplifier into a constant voltage.

6. The apparatus according to claim 1, wherein said drive unit comprises:
a terminal connectible to a power supply source for supplying DC power supply;
a transistor having a base terminal receiving the DC signal output from said controlling unit outputting and interrupting a variable collector current in a given period based on a level of base current that is inputted to said base terminal, thereby iteratively switching the collector current;
a first inductor provided between said power supply source and a collector terminal of said transistor, generating a variable primary electromotive force, depending on the level of current that is outputted and interrupted from said collector terminal in a given period;
a second inductor coupling-connected to said first inductor, generating a secondary inductive electromotive force that is induced from the primary electromotive force and boosted by a given multiple; and
a capacitor connected in parallel with said second inductor, providing the fluorescent lamp with a high voltage of high frequency which is generated by forming resonance with said second inductor in a given period.

7. The apparatus according to claim 6, wherein said drive unit further comprises:
a third inductor generating an inductive electromotive force having the same direction as that of the electromotive force which is generated by said first inductor and boosting forward bias voltage and backward bias voltage which are applied to the base terminal of said transistor, the third inductor being connected between the output terminal of said controlling unit and the base terminal of said transistor and being coupling-connected to said first inductor.

8. A scanning apparatus using a fluorescent lamp illuminating a manuscript and a scan unit receiving the light reflected from the manuscript and scanning the manuscript, said scanning apparatus comprising:
a central processing unit (CPU) controlling said scan unit to be in one of the stand-by mode, the scan mode and/or the sleep mode and outputting a square wave signal having a variable duty ratio according to the operation mode of said scan unit;
a rectifying unit receiving the square wave signal from said CPU, rectifying the square wave signal into different levels of DC voltage based on the duty ratio of the square wave signal, and outputting the rectified DC voltage;
a feedback unit detecting a voltage applied to the fluorescent lamp and outputting the detected voltage as a feedback signal;
a controlling unit controlling the voltage applied to said fluorescent lamp based on the feedback signal that is inputted from said feedback unit, said controlling unit outputting a control signal variably controlling the voltage applied to the fluorescent lamp based on the level of the DC voltage that is inputted from said rectifying unit;
a drive unit applying variable AC voltage to the fluorescent lamp based on the control signal that is inputted from said controlling unit, thereby driving the fluorescent lamp.

9. The scanning apparatus according to claim 8, wherein said CPU interrupts outputting of the square wave signal by maintaining the duty ratio at zero if said scan unit is in the stand-by mode.

10. The scanning apparatus according to claim 8, wherein if said CPU receives a scan command while said CPU controls the operation mode of the scan unit to be one of the sleep mode or the stand-by mode, said CPU outputs the square wave signal having a certain duty ratio for a given short time, resulting in the fluorescent lamp being rapidly preheated, the duty ratio having a percentage which enables the drive unit to provide the fluorescent lamp with the maximum voltage applicable thereto;
wherein if said CPU controls the scan unit to be in the scan mode and the scan unit performs the scanning operation, said CPU outputs the square wave signal having a certain duty ratio, the duty ratio having a certain percentage which enables the fluorescent lamp to stably emit the light in a constant amount; and
wherein if the scanning operation of said scan unit is completed, said CPU directs said scan unit to go into the stand-by mode.

11. The scanning apparatus according to claim 10, wherein if said CPU receives the scan command while said CPU controls the operation mode of the scan unit to be one of the sleep mode or the stand-by mode, said CPU outputs the square wave signal having a duty ratio which increases in a linear manner during a first time period and changes in a non-linear manner during a subsequent time period.

12. The scanning apparatus according to claim 8, wherein if said CPU does not receive a scan command for a given period while said CPU controls the operation mode of said scan unit to be in the stand-by mode, said CPU controls said scan unit to go into the sleep mode, thereby minimizing the power consumption of said scan unit.

13. The scanning apparatus according to claim 8, wherein said rectifying unit comprises:
a resistor dropping the voltage of the square wave signal that is inputted from said CPU and outputting the dropped voltage; and
a capacitor connected in parallel between said resistor and potential, rectifying the dropped voltage of the square wave signal into the DC voltage.

14. The scanning apparatus according to claim 8, wherein said feedback unit comprises:
a diode and a capacitor receiving the AC voltage applied to the fluorescent lamp, rectifying the AC voltage into the DC voltage, and outputting the rectified DC voltage; and
a resistor element connected so as to output the rectified DC voltage as the feedback signal to said capacitor.

15. The scanning apparatus according to claim 8, wherein said controlling unit comprises a terminal connectible to a reference voltage source generating a given DC voltage; and
wherein said controlling unit receives a first input voltage and a second input voltage that is inputted from said rectifying unit and outputs a signal to said drive unit that is proportional to the magnitude of the voltage difference between the second input voltage and the first input voltage, the first input voltage being the summation of the feedback signal output from said feedback unit and the reference voltage output from said reference voltage source.

16. The apparatus according to claim 15, wherein said controlling unit comprises:
an error amplifier amplifying the voltage difference and outputting the amplified voltage difference, said error amplifier having an inverting terminal that is inputted with the first input voltage and a non-inverting terminal that is inputted with the second input voltage; and
a first resistor connected in series with an output terminal of said error amplifier limiting the amount of current output from said error amplifier.

17. The apparatus according to claim 16, wherein said controlling unit further comprises:
a first capacitor and a first resistor connected in series between the output terminal of said error amplifier and said non-inverting terminal, canceling out the oscillation of the output voltage of said error amplifier; and
a second resistor and a second capacitor connected in series between the output terminal of said error amplifier and a ground terminal rectifying the ripple voltage in the output voltage of said error amplifier into a constant voltage.

18. The apparatus according to claim 8, wherein said drive unit comprises:
a terminal connectible to a power supply source for supplying DC power supply;
a transistor having a base terminal receiving the signal output from said controlling unit, outputting and interrupting a variable collector current in a given period based on the level of base current that is inputted to said base terminal, thereby iteratively switching the collector current;
a first inductor provided between said power supply source and the collector terminal of said transistor, generating a variable primary electromotive force, depending on the level of current that is outputted and interrupted from said collector terminal in a given period;
a second inductor coupling-connected to said first inductor, generating a secondary inductive electromotive force that is induced from the primary electromotive force and boosted by a given multiple; and
a capacitor connected in parallel with said second inductor, providing the fluorescent lamp with a high voltage of high frequency which is generated by forming resonance with said second inductor in a given period.

19. The apparatus according to claim 18, wherein said drive unit further comprises:
a third inductor generating an inductive electromotive force having the same direction as that of the electromotive force which is generated by said first inductor and boosting forward bias voltage and backward bias voltage which are applied to said base terminal of said transistor, the third inductor being connected between the output terminal of said controlling unit and the base terminal of said transistor and being coupling-connected to said first inductor.

20. A method of controlling a fluorescent lamp, comprising:
detecting a voltage applied to a fluorescent lamp;
feeding back the detected voltage to a control unit controlling luminous-intensity of the fluorescent lamp;
producing a control signal from the control unit variably controlling the voltage applied to the fluorescent lamp based on the detected voltage; and
applying a voltage level to the fluorescent lamp in an amount based on the control signal.

21. An apparatus variably driving the luminous intensity of a fluorescent lamp based on a control signal from a control unit, comprising:
a first inductor connected to a direct current power supply source;
a transistor having a collector terminal connected to the first inductor with the first inductor between the transistor and the power supply source, the transistor being activated by the base terminal receiving a direct current input from the control unit;
a second inductor electromagnetically coupled to the first inductor; and
a capacitor connected in parallel with the second inductor;
wherein activation of the transistor causes an increasing current flow through the first inductor generating a primary electromotive force until the current flow exceeds a saturation current amount such that the transistor enters a cut-off state cutting-off the current flow through the first inductor resulting in a switching operation generating forward and backward primary electromotive forces in the first inductor thereby inducing a higher voltage secondary electromotive force in the second inductor which forms a high resonant frequency with the capacitor such that the voltage applied to the lamp includes the high voltage and the high resonant frequency.

22. The apparatus of claim 21, further comprising:
a third inductor provided between the base terminal of the transistor and the control unit; and
a resistor in series with the third inductor and between the base terminal and the control unit;
wherein the third inductor and the resistor boost forward and backward bias voltages to the transistor.

23. A method of variably driving the luminous intensity of a lamp, comprising:
repeatedly activating and cutting-off a transistor to generate forward and backward primary electromotive force in a first inductor;
inducing a higher voltage secondary electromotive force in a second inductor;
forming a high resonant frequency with a capacitor in parallel with the second inductor; and
applying the higher voltage with the high resonant frequency to the lamp.
